(19) United States
(12) Patent Application Publication
(10) Pub. No.: US 2008/0123718 A1
(43) Pub. Date: May 29, 2008

(54) POSITIONING APPARATUS AND CONTROL METHOD THEREOF

(75) Inventor: Yosuke KOBAYASHI, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/736,738

(22) Filed: Apr. 18, 2007

(30) Foreign Application Priority Data
Oct. 28, 2005 (JP) 2005-314028

(51) Int. Cl. H04B 1/707

(52) U.S. Cl. 375/145; 375/E01.002

(57) ABSTRACT

A positioning apparatus is provided that reduces the time required to acquire spreading codes of satellite signals. In a positioning apparatus (100) having a plurality of channels CH1, CH2, . . . , a spreading code generator (104) provided for each channel generates a spreading code of a GPS satellite which is set by a control section (107). A spreading code phase control section (109) sets the initial phases of spreading codes set on the channels, respectively, such that the initial phases are sifted between the channels CH1 and CH2. When one channel (e.g., CH1) succeeds in acquiring a spreading code, the initial phase of the spreading code of another channel (CH2) is reset based on a spreading code phase of the one channel.

### CROSS REFERENCE TO RELATED APPLICATIONS

The disclosure of Japanese Patent Application No. 2005-314028, filed on Oct. 28, 2005, including the specification, drawings and abstract, is incorporated herein by reference in its entirety.

### BACKGROUND OF THE INVENTION

1. Field of the Invention

The present invention relates to a positioning apparatus that utilizes global navigation satellite system (GNSS) satellites and a control method for the positioning apparatus.

2. Description of the Related Art

Conventionally, a positioning apparatus that utilizes the global navigation satellite system (GNSS) using satellites, such as the GPS system run by the United States or the GLONASS (Global Navigation Satellite System) system run by Russia, simultaneously receives radio waves from a plurality of GNSS satellites and obtains navigation messages (orbital information and time information) from the GNSS satellites and thereby calculates an absolute location on Earth.

A positioning apparatus that utilizes satellites normally receives signals from four or more satellites simultaneously, acquires the carriers and track the spreading codes, and performs an inverse spread spectrum process and demodulates navigation data from the satellite signals. In addition, by using the navigation data or the like, the times the satellites transmitted signals are calculated and a pseudo-distance is determined per satellite (i.e. the time the satellite signals took to reach the positioning apparatus), and the location of the positioning apparatus is determined based on the obtained pseudo-distances.

At present, GPS receivers are widely utilized and are utilized in various fields such as car navigation systems, mobile phones, aircraft control and crustal movement survey. However, with expansion of application fields, it becomes difficult for GPS alone to meet required performance for positioning accuracy and reliability. In the United States where GPS is run, as part of GPS modernization policy, in addition to the existing L1 civilian frequency band, by adding new civilian signals to different frequency bands, improvements in positioning accuracy and reliability are planned.

In the existing L1 band, signals obtained by BPSK modulating 50-bps navigation data indicating the time and location, by a spreading code called a C/A (Coarse/Acquisition) code of a carrier frequency of 1.575 GHz, coding rate of 1.023 Mbps, code length of 1023 chips, and a period of 1 msec, are transmitted to the ground. For the new frequency bands, two bands, an L2 band and L5 band, are planned. In the L2 band, 25-bps navigation data is BPSK modulated, in a time division manner, by two spreading codes, an L2CM code of a carrier frequency of 1.227 GHz, coding rate of 1.023 Mbps, and code length of 10230 chips, and an L2CL code of a carrier frequency of 1.227 GHz, coding rate of 1.023 Mbps, and code length of 767250 chips. Thus, the periods of the codes are 20 msec and 1.5 seconds, respectively. In the L5 band, data is QPSK modulated by an I5/Q5 spreading codes of a carrier frequency of 1.176 MHz, coding rate of 10.23 Mbps, code length of 10230 chips and period of 1 msec.

A conventional positioning apparatus will be described below with reference to FIG. 1.

FIG. 1 is a functional block diagram showing a conventional positioning apparatus. In FIG. 1, antenna section 1 receives radio waves from GPS satellites. Down-conversion section 2 down-converts the satellite signal received by antenna section 1 to an intermediate frequency signal, and performs A/D conversion on the intermediate frequency signal. Carrier generator 3 generates a predetermined frequency signal and multiplies this with the intermediate frequency signal, and thereby removes the carrier component contained in the intermediate frequency signal. Spreading code generator 4 generates a predetermined spreading code and multiplies this with the intermediate frequency signal from which the carrier component has been removed. Integrators 5 and 6 perform time-integration on the I phase of the intermediate frequency signal and the Q phase that is 90 degrees out of phase with the I phase, in a predetermined period. Control section 7 is a control section that selects satellites to be scanned, performs tracking control of received signals, and obtains navigation messages transmitted from the satellites.

The spreading codes are unique for all satellites and include the above-described C/A code, L2CM code, L2CL code, I5 code, Q5 code. Acquisition of a spreading code of a satellite is performed as follows. First, a target satellite is selected by control section 7 and the same spreading code as the spreading code of the target satellite, is generated by spreading code generator 4. Then, a correlation process is performed by multiplying the generated spreading code and the spreading code of the satellite signal, and control is performed such that phases of the spreading codes match. To allow the phases to match, provided that spreading codes have characteristics that when the phases match the maximum correlation value is obtained and when the phases do not match the correlation value is 0, a correlation process is performed by shifting the phases generated by spreading code generator 4 by a predetermined number and is repeated until the integral values calculated by integrators 5 and 6 become maximum, i.e., until the spreading code of the target satellite is acquired (see Japanese Patent Application Laid-Open No. HEI2-103487, for example).

However, in the above-described conventional positioning apparatus, a long time is required until the spreading code of a satellite signal is acquired, and, in particular, when the code period of the spreading code is long, there is a problem that the time required to acquire the signal increases in proportion to the code period.

### SUMMARY OF THE INVENTION

It is therefore an object of the present invention to provide a positioning apparatus that reduces the time required to acquire the spreading codes of satellite signals.

The present invention attain the above-described object by a positioning apparatus having: a plurality of spreading code generation sections, that are provided per channel and that acquire spreading code signals transmitted from a plurality of target satellites, respectively; a spreading code phase prediction section that calculates a spreading code phase difference per target satellite; and a spreading code phase control section that sets initial phases of spreading codes set in the spreading code generation sections such that the initial phases are shifted per channel according to spreading code phase differences calculated in the spreading code phase prediction section.

In addition, the present invention attains the above-described object by a control method for a positioning apparatus including: a code generation step of generating a plurality of spreading codes, that are provided per channel to acquire spreading code signals transmitted from a plurality of target satellites; a spreading code phase prediction step of calculating a spreading code phase difference per target satellite; and a spreading code phase control step of setting initial phases of spreading codes set in the spreading code generation step such that the initial phases are shifted per channel according to spreading code phase differences calculated in the spreading code phase prediction step.

The present invention reduces the acquisition time of spreading codes, so that, compared to the conventional configuration, even when a spreading code of a long period is to be scanned, synchronization of the spreading code can be achieved in a short period of time. Consequently, a positioning apparatus can be implemented that can promptly receive satellite signals, calculate distances to satellites, and calculate the location of the positioning apparatus, with a simple configuration.

### BRIEF DESCRIPTION OF THE DRAWINGS

FIG. 1 is a block diagram showing a configuration of a conventional positioning apparatus;

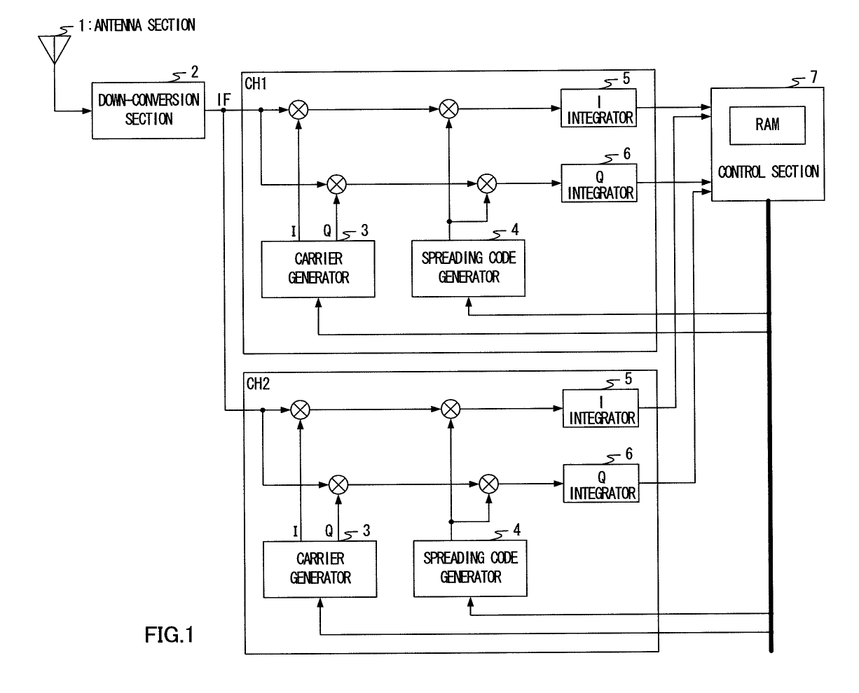

FIG. 2 is a functional block diagram showing a configuration of a positioning apparatus according to a first embodiment of the present invention;

FIG. 3 is a time chart showing an operation of a spreading code generator according to the first embodiment of the present invention;

FIG. 4 is a diagram describing an operation of the positioning apparatus according to the first embodiment of the present invention;

FIG. 5 is a functional block diagram showing a configuration of a positioning apparatus according to a second embodiment of the present invention; and

FIG. 6 is a functional block diagram showing a configuration of a positioning apparatus according to a third embodiment of the present invention.

### DETAILED DESCRIPTION OF THE PREFERRED EMBODIMENT

Embodiments of the present invention will be described in detail below with reference to the accompanying drawings.

### First Embodiment

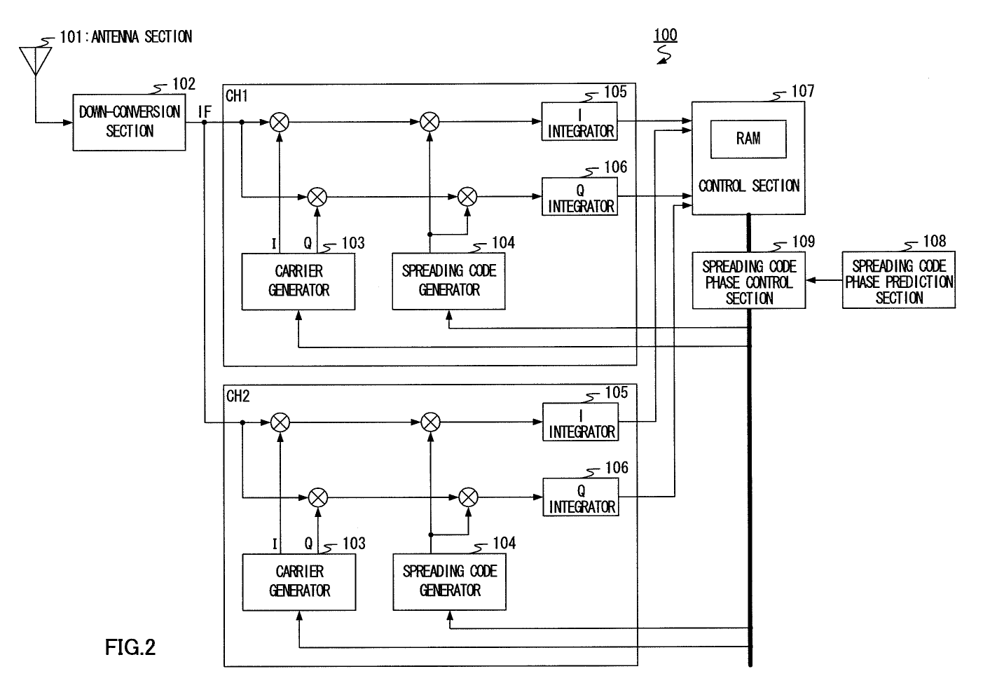

FIG. 2 is a functional block diagram showing the configuration of positioning apparatus 100 according to a first embodiment of the present invention. Positioning apparatus 100 mainly includes: antenna section 101; down-conversion section 102; carrier generator 103, spreading code generator 104, I integrator 105 and Q integrator 106, which are provided for each channel; control section 107; spreading code phase prediction section 108; and spreading code phase control section 109.

Antenna section 101 receives radio waves from satellites. Down-conversion section 102 down-converts the satellite signal received by antenna section 101 to an intermediate frequency signal and performs analog-digital conversion (A/D conversion) on the intermediate frequency signal and then outputs the result to the channels.

In each channel, carrier generator 103 generates a predetermined frequency signal and multiplies this with the intermediate frequency signal inputted from down-conversion section 102, and thereby removes the carrier component contained in the intermediate frequency signal. Spreading code generator 104 generates a predetermined spreading code for satellite acquisition and multiplies this with the intermediate frequency signal from which the carrier component has been removed, and thereby determines the correlation with the spreading code signal from the satellite. Thus, spreading code generator 104 is comprised of a predetermined number of shift registers which is determined by the type of spreading code. Spreading code generator 104 sets a value that is uniquely determined per satellite as the initial value of a shift register and applies a clock, and thereby generates a spreading code of a target satellite. Integrators 105 and 106 perform time integration on the I phase of the intermediate frequency signal and the Q phase that is 90 degrees out of phase with the I phase, in a predetermined period.

Control section 107 performs control to select satellites to be scanned, perform tracking control of received signals, and obtain navigation messages transmitted from the satellites.

Spreading code phase prediction section 108 predicts phase differences between scanning target satellites based on satellite orbital information and rough locations of current locations. Spreading code phase control section 109 has spreading code generators 104 generate spreading codes of the scanning target satellites set by control section 107 and thereupon controls the phases of the spreading codes generated by spreading code generators 104 based on the phase difference estimated by spreading code phase prediction section 108.

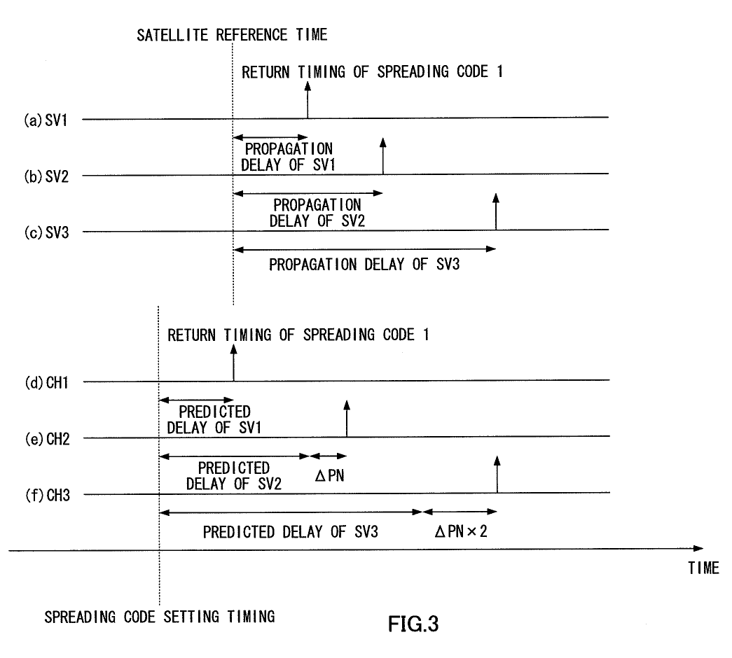

FIG. 3 is a time chart showing the operation of spreading code generators 104. The operations of spreading code phase control section 109 and spreading code phase prediction section 108 will be described first based on FIG. 3.

In FIG. 3, (a), (b) and (c) show satellite transmission signals that reach positioning apparatus 100. Although all satellites (SV1, SV2 and SV3) are time-synchronized with high accuracy and the time the spreading code is transmitted is the same for all the satellites, channel differences caused before reaching positioning apparatus 100 vary between the satellites. Spreading codes transmitted from the respective satellites (SV1, SV2 and SV3) are also synchronized with the above-described time, and the return timing of the spreading code is also common between all the satellites. However, due to the channel differences, as shown in FIG. 3, spreading codes are received such that the return timing of spreading code received by positioning apparatus 100 varies between the satellites.

In FIG. 3, (d), (e) and (f) show spreading codes to be set for the respective channels of positioning apparatus 100. Here, SV1, SV2 and SV3 satellites are set on channels CH1, CH2 and CH3, respectively, as scanning target satellites.

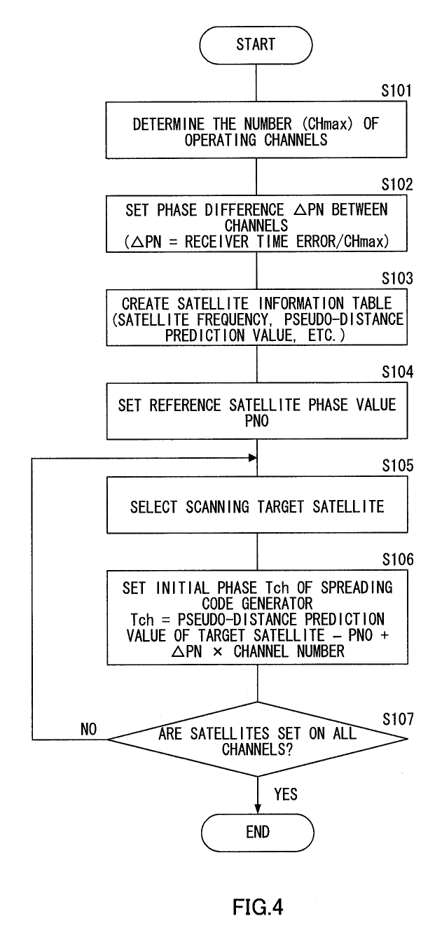

FIG. 4 is a diagram describing the operation of positioning apparatus 100 according to the first embodiment. The operation of positioning apparatus 100 will be described below based on FIG. 4.

First, in step S101, positioning apparatus 100 determines the number of channels to operate, CHmax. A generic GPS receiver has about 8 to 30 channels, and, normally the maximum value of the number of channels is set. However, as the number of operating channels increases, power consumption increases, and, consequently, an arbitrary number of channels can also be set.

Then, in step S102, positioning apparatus 100 estimates the receiver time error with respect to the satellite time, in the range of the corresponding spreading code period. When the receiver time is synchronized with the satellite time, the receiver time error is 0, and, when the receiver time is not synchronized with accuracy within the spreading code period, the receiver time error assumes the value of the spreading code period. The calculated receiver time error is divided by the number of operating channels CHmax to calculate ΔPN, and ΔPN is stored in a RAM in control section 107.

In step S103, positioning apparatus 100 computes satellite coordinates using satellite orbital information and calculates the elevation angle or azimuth for each satellite, as viewed from the positioning apparatus. In addition, by using a rough location where positioning apparatus 100 is installed and the satellite coordinates, a rough value of the distance from positioning apparatus 100 to each satellite (hereinafter referred to as a “pseudo-distance prediction value”) is calculated, and these information are stored in the RAM as a satellite information table.

In step S104, positioning apparatus 100 sets a pseudo-distance prediction value of an arbitrary satellite in the satellite information table, to a reference satellite phase value PN0. In selecting an arbitrary satellite, given that the pseudo-distance prediction value of each satellite includes an error in the rough location of the positioning apparatus utilized for the calculation of the prediction value and that this error usually varies between satellites, the satellite with a minimum estimation error (the satellite with the highest elevation angle) is selected.

Then, in step S105, positioning apparatus 100 selects satellites to be scanned, using the satellite information table and sets the numbers of the selected satellites in spreading code generator 104. Normally, in the satellite information table, to improve the signal detection rates from satellites, a satellite with a high elevation angle or a satellite having an earlier reception record is placed at the beginning, and thus a selection may be sequentially made from the beginning of the satellite information table.

In step S106, positioning apparatus 100 calculates the initial phase Tch of spreading code generator 104 for each channel by the following equation 1, and the initial phases of the satellites set in spreading code generators 104 are set in order of channel number (n). For a channel for which satellite orbital information is not available and the initial phase Tch cannot be calculated, the initial phase Tch is set to 0 or ΔPN×channel number (n). In this manner, the initial value setting in spreading code generator 104 is sequentially performed sequentially for all channels and satellite setting is performed on all channels (S107).

Initial phase Tch of spreading code generator 104 of channel number n=pseudo-distance prediction value of a target satellite−phase value PN0 of a reference satellite+ΔPN×channel number (n) (Equation 1)

As described above, in spreading code generator 104, an initial value unique to a satellite needs to be set in a shift register. To do this, by preparing in advance a ROM table storing shift register values to be obtained upon shift by an arbitrary number of bits (number of phases) and setting an initial value corresponding to an arbitrary number of phases in the shift register of spreading code generator 104 using the ROM table, an arbitrary initial phase can be determined for each satellite. However, to hold the ROM table, it is necessary to hold capacity equal to the multiplication of the number of bits (several tens of bits) of the shift register, the number of spreading code chips (several thousand to several hundred thousand), and the number of satellites. Even if the ROM table is held with the number of chips being punctured, a large ROM needs to be provided to the positioning apparatus, causing an increase in the scale of the positioning apparatus. In view of this, without holding a ROM table, an initial phase Tch of each channel is converted into time using a spreading code speed and scanning of only a channel on which a reference satellite is set is started. Then, scanning may be started after the time into which the initial phase Tch of each channel is converted has elapsed from the start of the phase scanning of the reference satellite channel.

When initial phases of all channels are set in the above-described manner, scanning of satellite signals is started, and at least one channel has detected a signal, a pseudo-distance prediction value of the channel is reset to PN0, initial phases Tch of all channels are recomputed, and scanning of satellite signals is resumed.

As described above, with the first embodiment, the initial phase of each channels of positioning apparatus 100 is shifted within a range of a receiver time error and set, thereby enabling signal detection of the channel with the smallest error among the initial phases set on the channels in a short period of time, so that, even if a spreading code period is long, signal detection is performed promptly and satellites can be acquired, without providing special circuitry.

### Second Embodiment

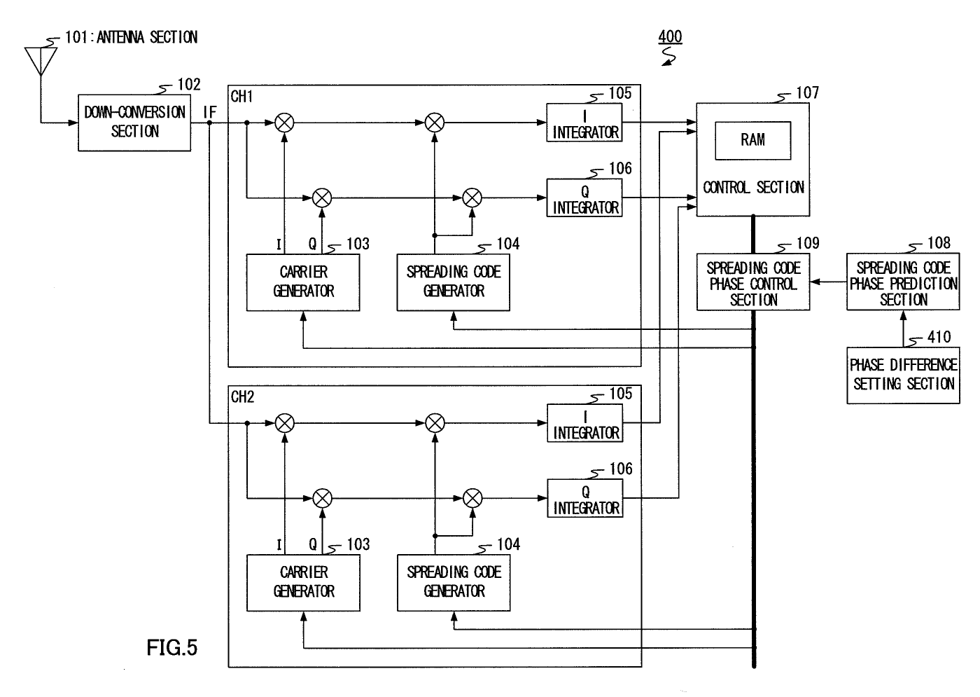

FIG. 5 is a functional block diagram showing the configuration of positioning apparatus 400 according to a second embodiment of the present invention. FIG. 5 shows a configuration with an addition of phase difference setting section 410 to the configuration shown in FIG. 2. Note that in FIG. 5 the same components as those in FIG. 2 are denoted by the same reference numerals and the description thereof will be omitted.

Features of positioning apparatus 400 according to the second embodiment include adding to spreading code phase prediction section 108 phase difference setting section 401 that externally sets the phase difference of each channel, so that, even when the characteristics of the reference clock of positioning apparatus 400 change or when the range of use of positioning apparatus 400 changes, the phase difference to be set on each channel can be calculated accurately.

Phase difference setting section 410 is installed inside positioning apparatus 400 and a user of positioning apparatus 400 can arbitrarily and externally set the phase difference ΔPN between channels, initial phase Tch, or rough location of positioning apparatus 400. In this case, as described in the first embodiment, ΔPN and pseudo-distance prediction value respectively include the receiver clock error and error in rough location where positioning apparatus 400 is installed.

First, regarding the receiver time error, when satellite signals are acquired and the location of the positioning apparatus is calculated, the receiver time can be synchronized with the satellite time with high accuracy, so that the receiver time error can be set to 0. When positioning is not possible, the receiver time is counted up with the internal clock of the receiver and accordingly error increases over time. Nevertheless, synchronization with the satellite time can be achieved within a range of receiver clock error. The receiver clock normally includes a TCXO (Temperature Compensated Crystal Oscillator). However, generally, crystal has characteristics that aged deterioration occurs after a long period of time passes. That is, since the estimation accuracy of a receiver time error degrades due to aged deterioration of crystal, by setting in phase difference setting section 410 a value that compensates for a characteristic change due to aged deterioration of crystal, or the like, scanning can be performed by a plurality of channels within a time according to the accuracy of the receiver time error. When positioning apparatus 400 includes an external communication means such as a mobile phone, it is also possible to externally acquire satellite time information and reset a receiver time error. When a rough location of positioning apparatus 400 can be acquired externally, by setting the rough location, it is also possible to estimate a pseudo-distance prediction value with high accuracy.

As described above, with positioning apparatus 400 according to the second embodiment, phase difference setting section 410 that externally sets the phase difference of each channel is added, and, even when the characteristics of the reference clock of positioning apparatus 400 change or when the range of use of positioning apparatus 400 changes, the setting value of phase difference setting section 410 is adjusted and the phase difference of each channel to be set by spreading code phase prediction section 108 can be calculated accurately. Accordingly, even when the characteristics of the reference clock of positioning apparatus 400 change or when the range of use of positioning apparatus 400 changes, the phase difference to be set on each channel can be maintained accurately.

### Third Embodiment

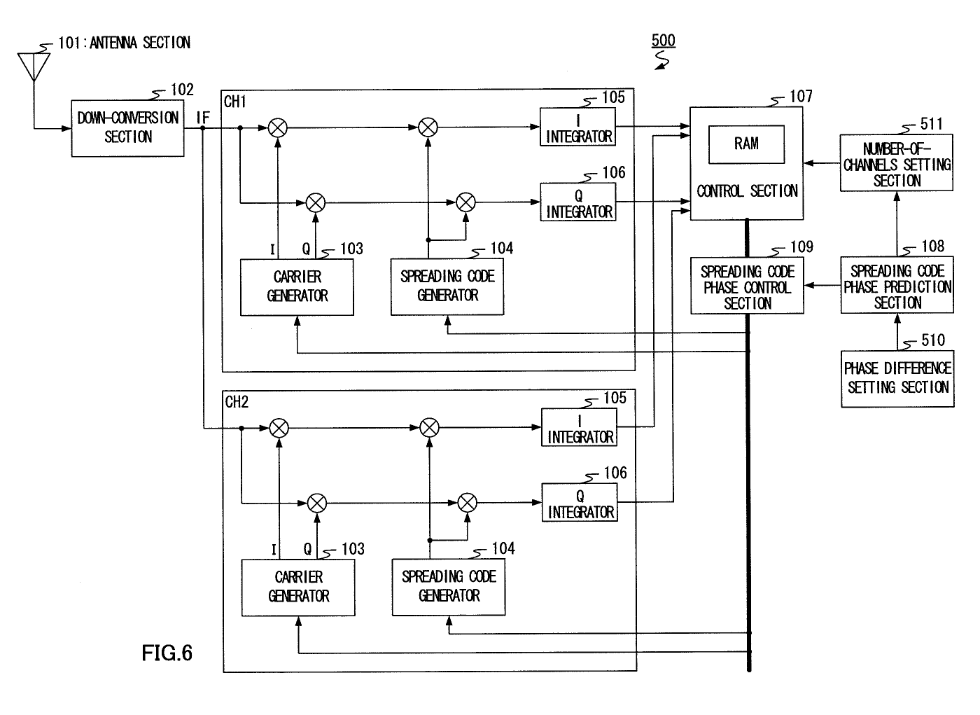

FIG. 6 is a functional block diagram showing the configuration of positioning apparatus 500 according to a third embodiment of the present invention. In FIG. 6 shows a configuration with additions of phase difference setting section 510 and a number-of-channels setting section 511 that sets the number of operating channels, to the configuration shown in FIG. 2. Note that, in FIG. 6, the same components as those in FIG. 2 are denoted by the same reference numerals and the description thereof will be omitted.

Features of positioning apparatus 500 according to the third embodiment include reducing power consumption by reducing the number of operating channels when a prediction range can be accurately determined and reducing the acquisition time of spreading codes by increasing the number of operating channels when the prediction range is wide.

Phase difference setting section 510 further includes, in addition to the function of phase difference setting section 410 described with reference to FIG. 5, a function of setting a specified value for ΔPN and maintaining the ΔPN value at the specified value. Although the specified value for ΔPN varies depending on the configuration of positioning apparatus 500, the specified value is set to an integral multiple of the quantization unit in I integrator 105 and Q integrator 106. Number-of-channels setting section 511 determines the number of operating channels for the number obtained by dividing the receiver time error by the specified value for ΔPN. To be more specific, number-of-channels setting section 511 selects the number of channels of positioning apparatus 500 using the spreading code phase difference for each satellite calculated by spreading code phase prediction section 108 and the spreading code phase difference error for each satellite. Accordingly, since the specified value for ΔPN is set to a fixed value, the number of operating channels is increased or reduced depending on the accuracy of the receiver time error.

As described above, with positioning apparatus 500 according to the third embodiment, when an prediction range can be accurately determined, the number of operating channels is reduced to reduce power consumption, and, when the prediction range is wide, the number of operating channels is increased to reduce the acquisition time of spreading codes, so that, when a prediction range can be accurately determined, power consumption can be reduced by reducing the number of operating channels, and, when the prediction range is wide, the acquisition time of spreading codes can be reduced by increasing the number of operating channels.

The present invention provides functions for promptly detecting a spreading code with a long spreading code period and is useful as a positioning apparatus that is capable of reducing the time required for positioning.

What is claimed is:

1. A positioning apparatus comprising:
a plurality of spreading code generation sections, that are provided per channel and that acquire spreading code signals transmitted from a plurality of target satellites, respectively;
a spreading code phase prediction section that calculates a spreading code phase difference per target satellite; and
a spreading code phase control section that sets initial phases of spreading codes set in the spreading code generation sections such that the initial phases are shifted per channel according to spreading code phase differences calculated in the spreading code phase prediction section.

2. The positioning apparatus according to claim 1, wherein the spreading code phase prediction section predicts errors included in the calculated spreading code phase differences for the satellites and determines a spreading code phase difference of each channel based on an amount of errors predicted.

3. The positioning apparatus according to claim 1, further comprising a phase difference setting section that externally sets a phase difference between adjacent channels in the spreading code phase control section.

4. The positioning apparatus according to claim 1, further comprising a number-of-channels setting section that selects a number of channels using the spreading code phase differences for the satellites calculated in the spreading code phase prediction section and spreading code phase difference errors for the satellites.

5. The positioning apparatus according to claim 1, wherein, when one of the channels acquires a satellite signal, the spreading code phase control section uses a spreading code phase set on the channel having acquired the satellite signal as a true value, and sets initial phases of spreading codes of other channels.

6. A positioning apparatus control method, comprising:
a code generation step of generating a plurality of spreading codes, that are provided per channel to acquire spreading code signals transmitted from a plurality of target satellites;
a spreading code phase prediction step of calculating a spreading code phase difference per target satellite; and
a spreading code phase control step of setting initial phases of spreading codes set in the spreading code generation step such that the initial phases are shifted per channel according to spreading code phase differences calculated in the spreading code phase prediction step.
